(19) United States
(12) Patent Application Publication
(10) Pub. No.: US 2010/0177889 A1
(43) Pub. Date: Jul. 15, 2010

(54) IMAGE FORMING APPARATUS AND ENCRYPTION PROCESS CONTROL METHOD

(75) Inventor: Masaru Koga, Shizuoka-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/686,816

(22) Filed: Jan. 13, 2010

Related U.S. Application Data
(60) Provisional application No. 61/145,005, filed on Jan. 15, 2009.

(51) Int. Cl. H04L 9/28

(52) U.S. Cl. 380/28

(57) ABSTRACT

An encryption process control technique is provided which can reduce the power consumption in an image forming apparatus including an exclusive circuit for an encryption process. The image forming apparatus includes: a first encryption processor mounted as hardware to perform a data encrypting process; a second encryption processor mounted as software to perform a data encrypting process; a process controller determining which of the first encryption processor and the second encryption processor should be used to perform a data encryption process; and a power supply restrictor stopping or decreasing a supply of power to the first encryption processor when the process controller determines that the second encryption processor is used to perform the encryption process.

### CROSS-REFERENCE TO RELATED APPLICATION

This application is based upon and claims the benefit of priority from: U.S. provisional application 61/145, 005, filed on Jan. 15, 2009; the entire contents of each of which are incorporated herein by reference.

### TECHNICAL FIELD

The present invention relates to an image forming apparatus, and more particularly, to an encryption process control technique of performing a data encrypting process by the use of mounted hardware and mounted software.

### BACKGROUND

In the past, in image forming apparatuses such as digital multi-function peripherals (MFP), a technique of encrypting data acquired by scanning or the like and stored in a predetermined memory area by an encryption process from the viewpoint of prevention of overwriting or the like was known. Here, the encryption process often treats image data. Accordingly, to prevent an increase in computation load or a decrease in processing speed resulting from the encryption process, the image forming apparatuses often include an exclusive circuit (hardware) performing an encryption process and perform the encryption process by the use of the hardware.

However, when the encryption process is performed by only the exclusive circuit performing an encryption process, the power consumption in the image forming apparatuses is greater than that in the image forming apparatuses not including the exclusive circuit.

### SUMMARY

According to an aspect of the invention, there is provided an image forming apparatus including: a first encryption processor mounted as hardware to perform a data encrypting process; a second encryption processor mounted as software to perform a data encrypting process; a process controller determining which of the first encryption processor and the second encryption processor should be used to perform an encryption process on the basis of information on an operation status of the image forming apparatus; and a power supply restrictor stopping a supply of power to the first encryption processor when the process controller determines that the second encryption processor is used to perform the encryption process.

According to another aspect of the invention, there is provided an encryption process control method including: determining which of an encryption process based on a first encryption function of an image forming apparatus mounted as hardware on the image forming apparatus and an encryption process based on a second encryption function of the image forming apparatus mounted as software on the image forming apparatus should be used to encrypt data on the basis of information on an operation status of the image forming apparatus performing an encryption process; and stopping a supply of power to the hardware corresponding to the first encryption function when it is determined that the encryption process based on the second encryption function is used to encrypt data.

According to still another aspect of the invention, there is provided an image forming apparatus including: a first encryption processor mounted as hardware to perform a data encrypting process; a second encryption processor mounted as software to perform a data encrypting process; a process controller determining which of the first encryption processor and the second encryption processor should be used to perform an encryption process on the basis of information on an operation status of the image forming apparatus; and a power supply restrictor stopping a supply of power to the first encryption processor when the process controller determines that the second encryption processor is used to perform the encryption process.

### DESCRIPTION OF THE DRAWINGS

FIG. 1 is a perspective view schematically illustrating the configuration of an image forming apparatus (MFP 101) according to a first embodiment of the invention.

FIG. 2 is a diagram illustrating an example of an operation mode table in the MFP 101 according to the first embodiment of the invention.

FIG. 3 is a functional block diagram associated with an encryption process control of the MFP 101 according to the first embodiment of the invention.

FIG. 4 is a diagram schematically illustrating replacement of a library associated with an encryption process according to the first embodiment of the invention.

FIG. 5 is a diagram schematically illustrating relations between power sources supplying power and elements supplied with power from the power sources in the MFP 101 according to the first embodiment of the invention.

FIG. 6 is a diagram illustrating a flow of processes associated with the encryption process control according to the first embodiment of the invention.

FIG. 7 is a diagram illustrating an example of a data process table in an MFP 101 according to a second embodiment of the invention.

FIG. 8 is a diagram illustrating an example of a functional block setting table in the MFP 101 according to the second embodiment of the invention.

FIG. 9 is a functional block diagram associated with the encryption process control in the MFP 101 according to the second embodiment of the invention.

FIG. 10 is a diagram illustrating a flow of processes associated with the encryption process control according to the second embodiment of the invention.

### DETAILED DESCRIPTION

Hereinafter, embodiments of the invention will be described with reference to the accompanying drawings.

### First Embodiment

A first embodiment of the invention will be first described.

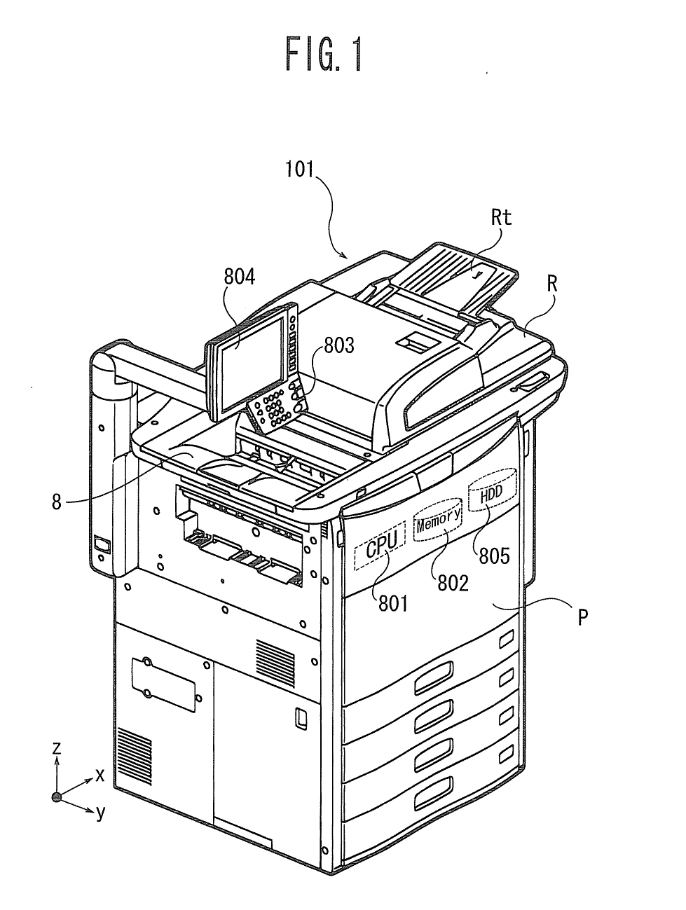

FIG. 1 is a perspective view schematically illustrating the configuration of an MFP (Multi Function Peripheral which corresponds to an image forming apparatus) 101 according to a first embodiment of the invention. The MFP 101 according to the first embodiment includes an auto document feeder Ra, an image reader R, an image forming device P, and a discharge tray 8.

The auto document feeder (ADF) Ra has a function of automatically continuously carrying plural sheets of original documents placed on a tray Rt to a predetermined reading position by the image reader R.

The image reader R is disposed in the upper side of the image forming apparatus body and has a function of scanning and reading images of the sheet of original document automatically carried by the auto document feeder A or a sheet of original document or a book document placed on an original document base not shown.

The image forming unit P has a function of forming a developer image on a sheet fed from a paper feeding cassette K on the basis of the image read from the original document by the image reader R or image data received from an external device by the MFP 101. Here, in the first embodiment, the image forming unit P includes a fixing unit not shown. The fixing unit heats a toner image, which is transferred onto the sheet, corresponding to the image data and fixing the toner image to the sheet.

The sheet on which an image is formed by the image forming unit P is discharged to the discharge tray 8.

The MFP 101 according to the first embodiment includes a CPU 801, a memory 802, and a hard disk (HDD) 805.

The CPU 801 serves to perform various processes in the MFP 101 and also serves to embody various functions by developing and executing programs stored in the HDD 805 in the memory 802.

The memory 802 includes, for example, a RAM (Random Access memory), a DRAM (Dynamic Random Access Memory), an SRAM (Static Random Access memory), and a VRAM (Video RAM)

The HDD 805 serves to store a variety of information or programs used in the MFP 101.

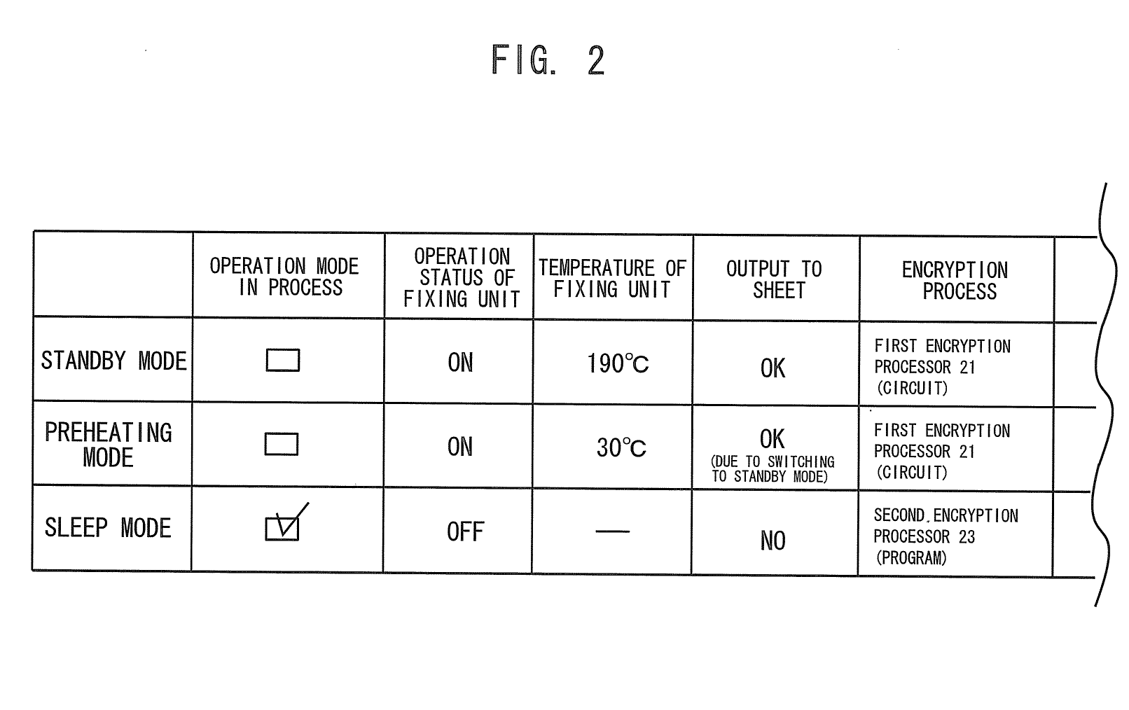

For example, as shown in FIG. 2, an operation mode table of operations modes in the MFP 101, which is constructed by the CPU 801 on the basis of the programs and data stored in the HDD 805, is stored in the memory 802. In the operation mode table, operation conditions in the MFP 101 in operation modes in addition to operation modes presently activated in the MFP 101, operation statuses of the fixing unit in the operation modes, and functional cores (of which details will be described later) performing an encryption process on temperature data of the fixing unit in the operation modes are defined and correlated with the operation modes.

In the first embodiment, the MFP 101 has three operation modes of a standby mode in which an image forming process (image output process) to a sheet is being performed or is going to be performed, a preheating mode in which the temperature of the fixing unit is lower than that in the standby mode but the fixing unit does not stop the heating operation, and a sleep mode in which the heating operation of the fixing unit (for example, the operation of heating a heating roller of the fixing unit) is stopped. The standby mode and the preheating mode correspond to the first operation mode. The sleep mode corresponds to the second operation mode in which the power consumption is smaller than that in the first operation mode.

As shown in FIG. 1, the MFP 101 includes a display 803 and an operation unit 804 including a graphical display mounted with a touch panel sensor, exclusive buttons for numerical values, start, cancel, and the like frequently used, and a status display LED. The MFP 101 includes standard elements such as a network interface for communication with the outside via a network and an external device interface (for example, a USB interface) for communication with an external device, in addition to a scanner and a printer.

Accordingly, the MFP 101 executes application programs stored in a memory area of the memory 802 or the like on the basis of a user's request acquired via the network or from the operation unit 804, and performs processes such as monochromatic or color copying, monochromatic or color scanning, and monochromatic or color printing.

Here, in the MFP 101 according to the first embodiment, the image data read by the image reader R or received via the network from the external device is stored in the HDD 805. At this time, the data to be stored is encrypted to prevent the data from being overwritten or the like.

In the first embodiment, the encryption process is performed by one of an encryption function mounted as a circuit on the MFP 101 and an encryption function mounted as a program on the MFP 101. Specifically, the CPU 801 causes the encryption function mounted as hardware to perform the encryption process when the MFP 101 is not in the sleep mode which is an operation mode with small power consumption (in other words, when it is in the standby mode or the preheating mode), on the basis of operation mode information which is a kind of information on the operation status of the MFP 101. On the other hand, the CPU 801 causes the encryption function mounted as software to perform the encryption process when the MFP 101 is in the sleep mode with small power consumption. When the encryption function mounted as a program performs the encryption process, the CPU 801 stops or decreases a supply of power to a circuit performing the encryption process when the operation mode is not the sleep mode with small power consumption.

In this specification, the hardware associated with the encryption function and the circuit associated with the encryption function are used in the same meaning. Similarly, the software associated with the encryption function and the program associated with the encryption function are used in the same meaning.

The decrease in supply of power in this specification will be described. In this specification, the decrease in supply of power means that when the hardware performing the encryption process and one or more other hardware pieces are supplied with power from one power source, the amount of supplied power is decreased in the state where the operation of the hardware performing the encryption process is deactivated but the operations of the other hardware pieces (for example, a FAX transceiver circuit) are activated.

Functional blocks for the encryption process control in the MFP 101 according to the first embodiment will be described now.

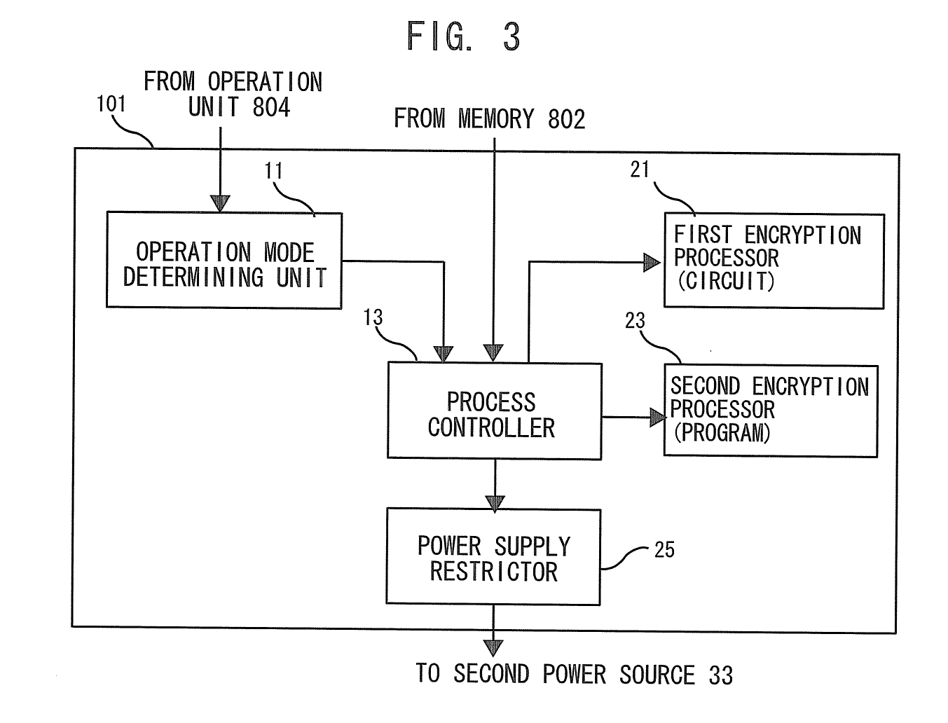

As shown in FIG. 3, the MFP 101 according to the first embodiment includes an operation mode determining unit 11, a process controller 13, a first encryption processor 21, a second encryption processor 23, and a power supply restrictor 25.

The operation mode determining unit 11 determines whether the MFP 101 is in the sleep mode in which the power consumption is smaller than that in the standby mode or the preheating mode when the encryption process is performed.

Specifically, the operation mode determining unit 11 first acquires operation mode specifying information (corresponding to operation mode information) which is information for specifying the operation mode of the MFP 101 on the basis of the user's operation input from the operation unit 804. Then, the operation mode determining unit 11 determines whether the operation mode specified by the operation mode specifying information is the sleep mode on the basis of the operation mode specifying information. Subsequently, the operation mode determining unit 11 constructs information on the determination result, and sends the constructed information to the process controller 13.

The process controller 13 determines the core (functional block) associated with the data encrypting process on the basis of the information on the determination result acquired from the operation mode determining unit 11. For example, the operation mode determining unit 11 may determine that the operation mode specified by the operation mode specifying information is the sleep mode. In this case, the process controller 13 determines to the second encryption processor 23 to be described later is used to perform the data encrypting process on the basis of the operation mode table stored in the memory 802. The operation mode determining unit 11 may determine that the operation mode specified by the operation mode specifying information is not the sleep mode, in other words, the standby mode or the preheating mode. In this case, the process controller 13 determines that the first encryption processor 21 to be described later is used to perform the data encrypting process on the basis of the operation mode table stored in the memory 802.

In the process of causing the process controller 13 to determine the functional block to perform the encryption process, the functional block corresponding to the operation mode specified by the operation mode specifying information may be different from the functional block corresponding to the operation mode in process. At this time, the process controller 13 switches the functional block performing the encryption process between the first encryption processor 21 and the second encryption processor 23 so that the functional block corresponding to the operation mode specified by the operation mode specifying information is used to perform the encryption process. The process controller 13 constructs information on the switching and sends out the constructed information to the power supply restrictor 25, when the functional block performing the data encrypting process is switched.

The switching of the function block performing the encryption process in the process controller 13 will be described specifically. Specifically, when the operation mode is switched from the standby mode or the preheating mode to the sleep mode and when the operation mode is switched from the sleep mode to the standby mode or the preheating mode, such switching is performed in the first embodiment.

First, in the first embodiment, the determination (distribution) on which of the first encryption processor 21 and the second encryption processor 23 should be used to perform the encryption process is carried out by loading a library (also referred to as “function table”) for determining the encryption processor to a specific area of the memory 802 set in advance just before transmitting data from a file system layer of the memory 802 to the HDD 805. More specifically, the MFP 101 includes a library (hereinafter, referred to as “first library”) for determining that the first encryption processor 21 is used to encrypt the data and a library (hereinafter, referred to as “second library”) for determining that the second encryption processor 23 is used to encrypt the data. The CPU 801 determines the functional block to perform the encryption process by loading one of the first library and the second library.

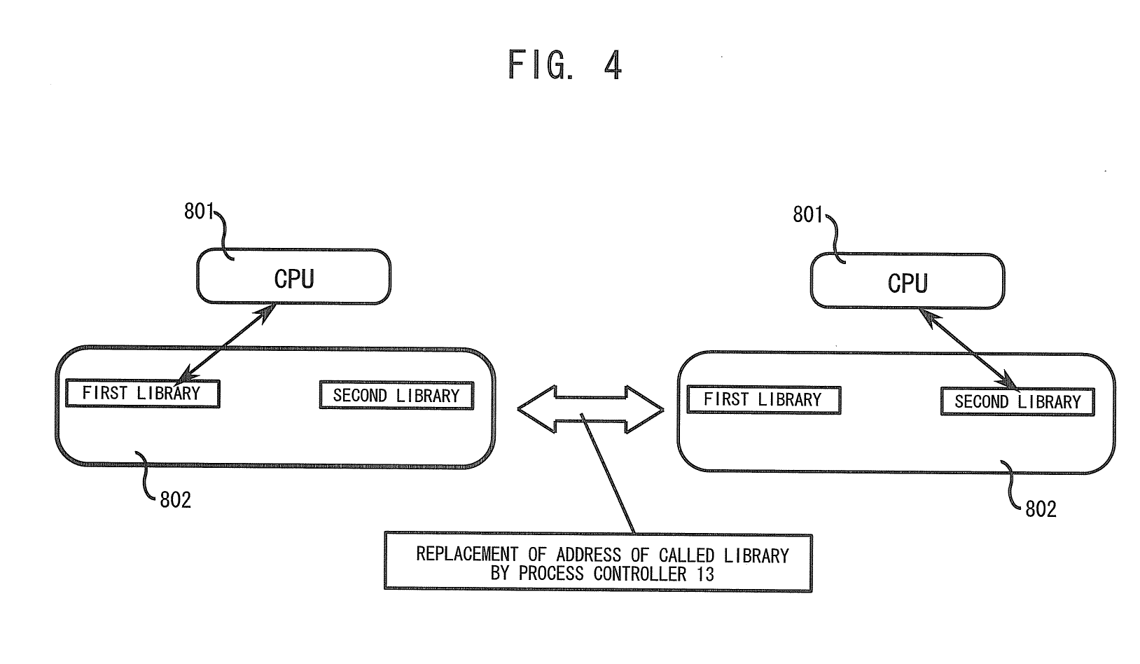

As shown in FIG. 4, in the first embodiment, a specific area corresponding to the first library and a specific area corresponding to the second library are secured by a function pointer are secured in the memory 802. The process controller 13 switches the function block performing the encryption process between the first encryption processor 21 and the second encryption processor 23 by replacing the address of the library loaded by the CPU 801 in the memory 802.

The first encryption processor 21 is mounted as a circuit performing a data encrypting process on the MFP 101. The encryption process using the first encryption processor 21 is smaller in computation load, which is applied to the CPU 801 in process, and greater in processing speed than the encryption process using the second encryption processor 23 to be described later. That is, by performing the encryption process using the first encryption processor 21, the overhead in encryption is reduced. On the other hand, the power consumption of the encryption process using the first encryption processor 21 is greater than that of the encryption process using the second encryption processor 23 to be described later.

The second encryption processor 23 is mounted as a program performing a data encrypting process on the MFP 101. The encryption process using the second encryption processor 23 is greater in computation load, which is applied to the CPU 801 in process, and smaller in processing speed than the encryption process using the first encryption processor 21. On the other hand, the power consumption of the encryption process using the second encryption processor 23 is smaller than that of the encryption process using the first encryption processor 21.

The power supply restrictor 25 controls the supply of power to the first encryption processor 21 on the basis of the corresponding information when the information on the switching of the functional block associated with the data encrypting process is acquired from the process controller 13.

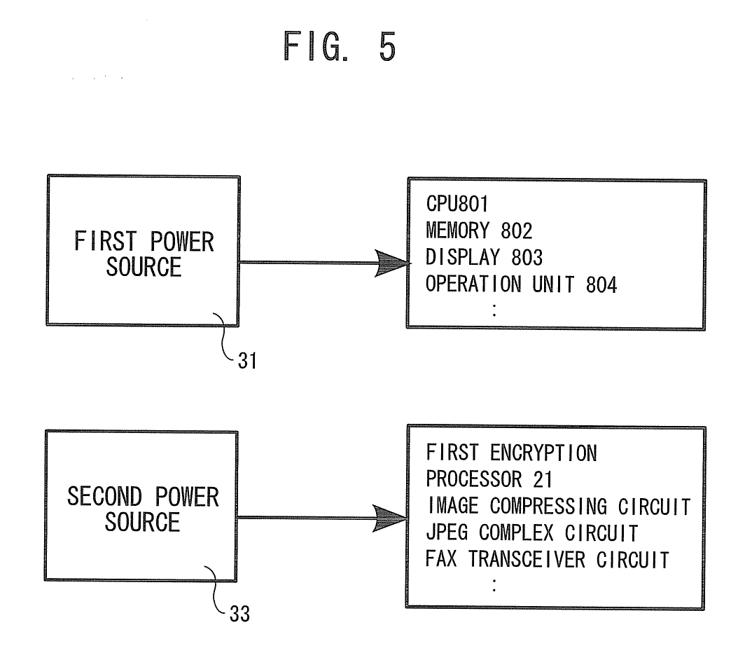

As shown in FIG. 5, in the first embodiment, the MFP 101 includes a first power source 31 supplying power to the CPU 801 and the like and a second power source 33 supplying power to the first encryption processor 21. In the first embodiment, when the information indicating that the functional block performing the data encrypting process is switched from the first encryption processor 21 to the second encryption processor 23 is acquired, the power supply restrictor 25 stops or decreases the supply of power from the second power source 33. When the information indicating that the functional block performing the data encrypting process is switched from the second encryption processor 23 to the first encryption processor 21 is acquired, the power supply restrictor 25 releases the stop or decrease of the supply of power from the second power source 33. In other words, the power supply restrictor 25 restarts or increases the supply of power from the second power source 33.

As shown in FIG. 5, in the first embodiment, the circuit operating in interlock with the encryption process using the first encryption processor 21 is also supplied with power from the second power source. Accordingly, in the first embodiment, when the supply of power from the second power source is stopped or decreased, the supply of power to the circuit operating in interlock with the encryption process using the first encryption processor 21 is stopped or decreased by interlocking with the stop or decrease of the supply of power to the first encryption processor 21.

By having this configuration, it is possible to further suppress the amount of power consumption in the MFP 101 when it is determined that the second encryption processor is used to perform the encryption process. Examples of the circuit operating in interlock with the encryption process using the first encryption processor 21 can include an image compressing circuit, a JPEG complex circuit, and a FAX transceiver circuit.

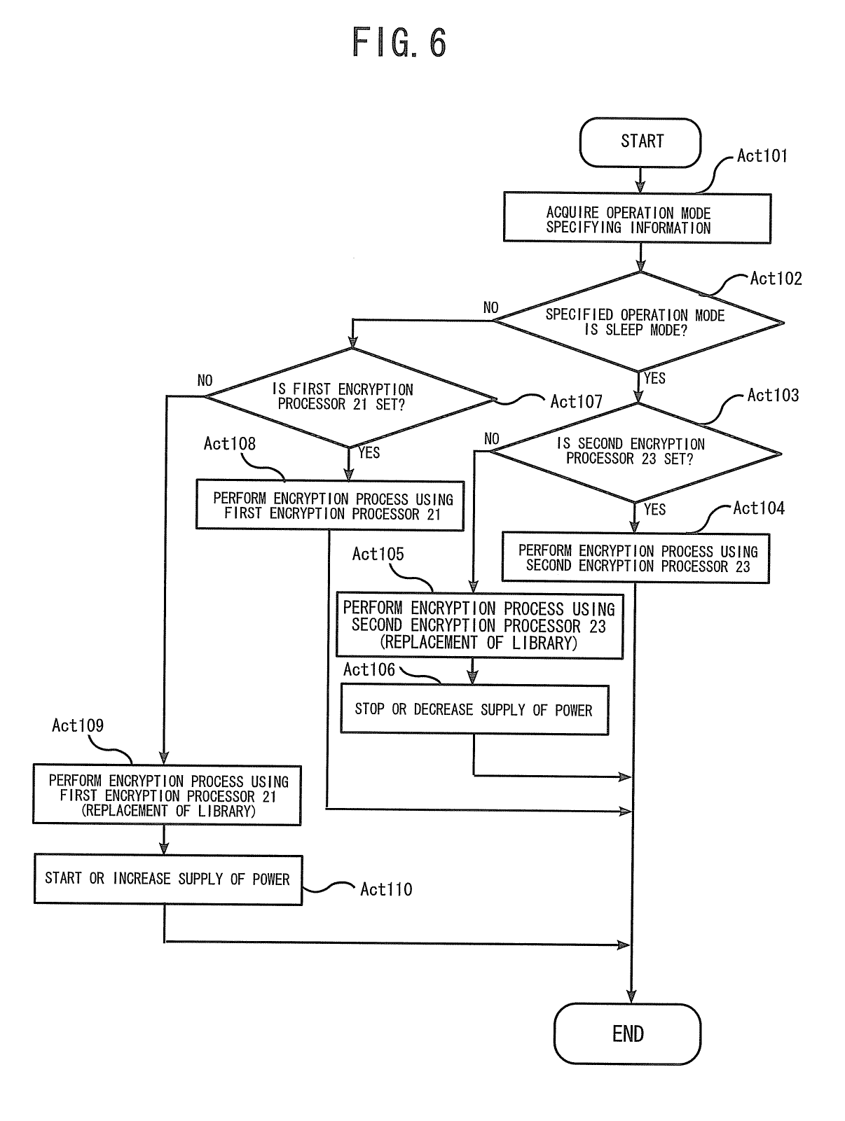

The flow of processes of the encryption process control will be described in detail with reference to FIG. 6.

First, in Act 101, the operation mode determining unit 11 acquires the operation mode specifying information for specifying an operation mode on the basis of an operation input.

Then, in Act 102, the operation mode determining unit 11 determines whether the operation mode specified by the acquired operation mode specifying information is the sleep mode. When it is determined that the specified operation mode is the sleep mode (Yes in Act 102), the operation mode determining unit 11 constructs information on the determination result indicating that the operation mode is the sleep mode, and sends the constructed information to the process controller 13. In Act 103, the process controller 13 determines whether the function block performing the encryption process is set to the second encryption processor 23 on the basis of the information on the determination result and the operation mode table.

When it is determined that the function block performing the encryption process is set to the second encryption processor 23 (Yes in Act 103), the process controller 31 causes the second encryption processor 23 to perform the encryption process without any change in Act 104.

On the other hand, it may be determined in Act 103 that the functional block performing the encryption process is not set to the second encryption processor 23 (No in Act 103). In this case, in Act 105, the process controller 13 switches the loaded library from the first library to the second library so as to cause the second encryption processor 23 to perform the encryption process. Then, the process controller 15 constructs the information indicating that the function block performing the encryption process is switched from the first encryption processor 21 to the second encryption processor 23, and sends the constructed information to the power supply restrictor 25.

The power supply restrictor 25 controls the second power source to restrict the supply of power (that is, to stop or decrease the supply of power) on the basis of the information indicating that the function block performing the encryption process is switched from the first encryption processor 21 to the second encryption processor 23 (Act 106). Accordingly, the supply of power to the first encryption processor 21 and the circuit operating in interlock with the encryption process using the first encryption processor 21 from the second power source is stopped or decreased.

It may be determined in Act 102 that the operation mode specified by the operation mode specifying information is not the sleep mode (No in Act 102). At this time, the operation mode determining unit 11 sends the information on the determination result indicating that the operation mode is the standby mode or the preheating mode to the process controller 13. In Act 107, the process controller 13 determines whether the function block performing the encryption process in the operation mode in process is set to the first encryption processor 21 on the basis of the information on the determination result and the operation mode table stored in the memory.

When it is determined that the functional block performing the encryption process is set to the first encryption processor 21 (Yes in Act 107), the process controller 31 causes the first encryption processor 21 to perform the encryption process without any change in Act 108.

On the other hand, it may be determined in Act 107 that the functional block performing the encryption process is not set to the first encryption processor 21 (No in Act 107). In this case, in Act 109, the process controller 13 switches the loaded library from the second library to the first library so as to cause the first encryption processor 21 to perform the encryption process. Then, the process controller 13 constructs the information indicating that the functional block performing the encryption process is switched from the second encryption processor 23 to the first encryption processor 21, and sends the constructed information to the power supply restrictor 25.

The power supply restrictor 25 controls the second power source to release (that is, to restart or increase the supply of power) the restriction of the supply of power on the basis of the information indicating that the functional block performing the encryption process is switched from the second encryption processor 23 to the first encryption processor 21 (Act 110). Accordingly, the supply of power to the first encryption processor 21 and the circuit operating in interlock with the encryption process using the first encryption processor 21 from the second power source is restarted or increased.

According to the first embodiment of the invention, since the encryption process using the program with small power consumption is performed in the sleep mode with small power consumption, it is possible to further suppress the power consumption in the MFP 101.

In the first embodiment, the functional block performing the encryption process is switched between the first encryption processor 21 and the second encryption processor 23 on the basis of the operation mode specified by the operation mode specifying information which is a kind of operation mode information. The operation mode determining unit 11 acquires the operation mode specifying information on the basis of the operation input.

However, the invention is not limited to this configuration, but may be modified in other forms. For example, when the MFP 101 does not perform an output process to a sheet for a predetermined time in standby mode or the preheating mode (the first operation mode), the operation mode is switched to the sleep mode (the second operation mode). When the operation mode is switched from the first operation mode to the second operation mode, the function block performing the encryption process is switched from the first encryption processor 21 to the second encryption processor 23.

In this case, when the operation mode is switched from the standby mode or the preheating mode to the sleep mode, the operation mode determining unit 11 acquires the operation mode information from an event log constructed by the CPU 801. Then, similarly to the first embodiment, the MFP 101 (specifically, the operation mode determining unit 11, the process controller 13, and the power supply restrictor 25) switches the functional block performing the encryption process from the first encryption processor 21 to the second encryption processor 23 and stops or decreases the supply of power to the first encryption processor 23.

In the first embodiment, the functional block performing the encryption process is switched before switching the operation mode or at the same time as switching the operation mode on the basis of the operation mode specifying information. However, the invention is not limited to this configuration, but the functional block performing the encryption process may be switched after switching the operation mode. For example, when the operation mode is completely switched, the CPU 801 may construct the information indicating the operation mode after the switching, and the operation mode determining unit 11 may determine the operation mode in which the encryption process is performed on the basis of the information indicating the operation mode after the switching.

In the first embodiment, the first operation mode includes an operation mode in which the fixing unit can operate (an operation mode in which the heating operation is performed) and the second operation mode in which the power consumption is smaller than that in the first operation mode includes an operation mode in which the fixing unit stops the heating operation. However, the invention is not limited to this configuration, but another operation mode may be included in the second operation mode as long as the power consumption thereof is smaller than that in the first operation mode. For example, the standby mode described in the first embodiment may be included in the first operation mode and the preheating mode described in the first embodiment may be included in the second operation mode.

### Second Embodiment

In the first embodiment, the functional block performing the encryption process is switched between the first encryption processor 21 (circuit) and the second encryption processor 23 (program) on the basis of the information on the operation mode based on the operation input.

In a second embodiment of the invention, the functional block performing the encryption process is switched between the first encryption processor 21 (circuit) and the second encryption processor 23 (program) on the basis of information (data process information) on a process performed on data which is a kind of information on the operation status and acquired in response to the operation input.

Specifically, the functional block performing the encryption process is switched between the first encryption processor 21 (circuit) and the second encryption processor 23 (program), depending on whether the image forming process of data acquired by the MFP 101 to a sheet is performed.

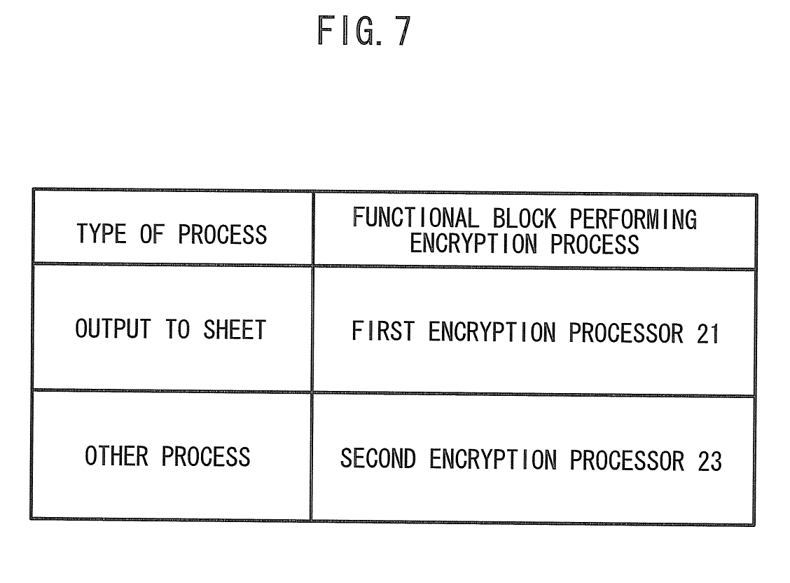

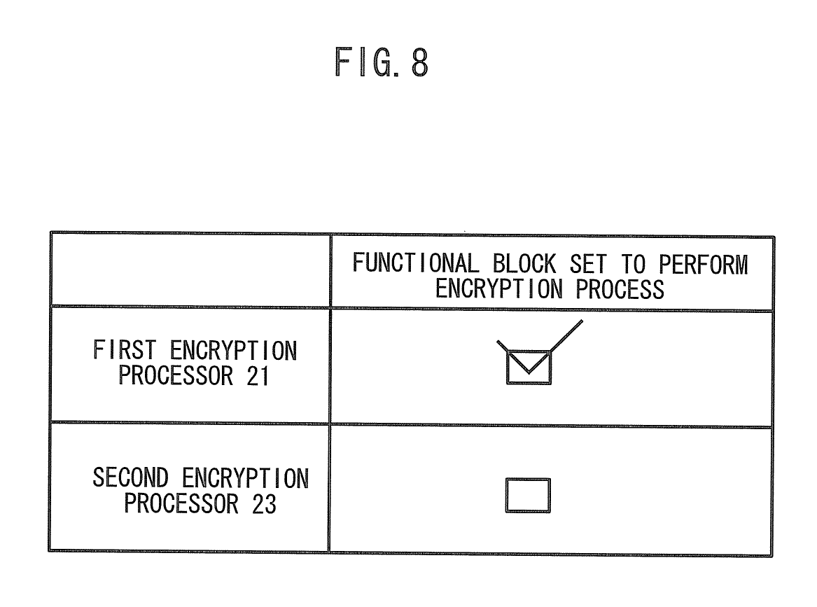

In the second embodiment, a data process table, which is constructed by the CPU 801 on the basis of the programs and data stored in the HDD 805, indicating the correspondence between the process on the acquired data and the functional block performing the encryption process and a functional block setting table, which is set in advance, indicating the functional blocks performing the encryption process are stored in the memory 802. The data process table is shown in FIG. 7 and the functional block setting table is shown in FIG. 8.

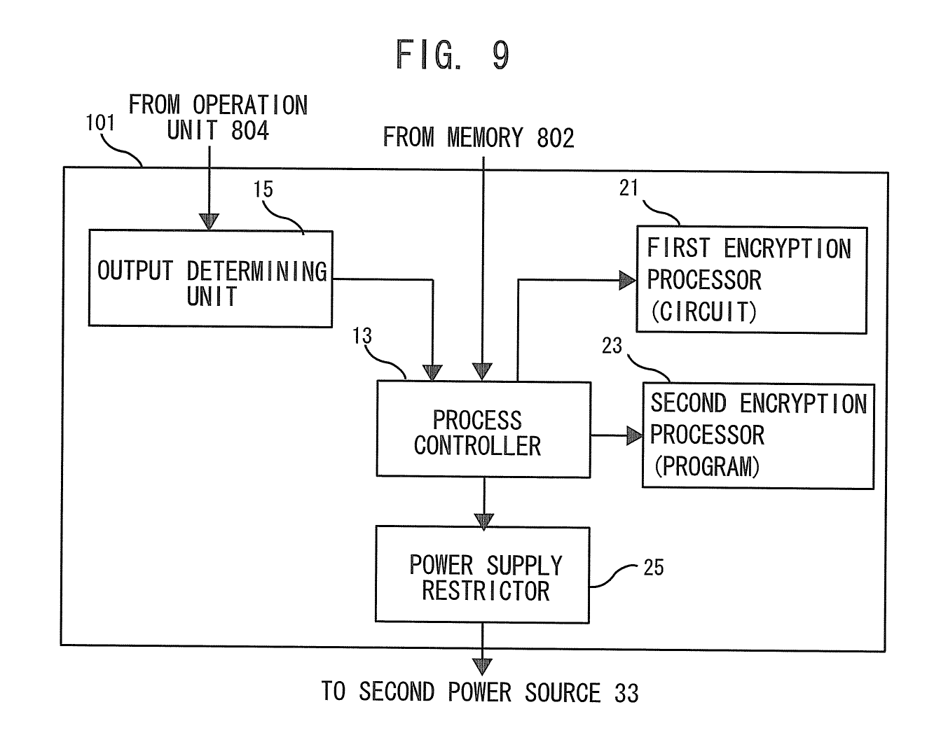

The functional block for controlling the encryption process in the second embodiment is shown in FIG. 9. As shown in FIG. 9, in the second embodiment, the MFP 101 includes an output determining unit 15 instead of the operation mode determining unit 11 used in the first embodiment. The functional blocks common to the first embodiment are referenced by like reference numerals and description thereof is not repeated.

The output determining unit 15 determines whether the output process to a sheet is performed on the data acquired by the MFP 101.

Specifically, the output determining unit 15 first acquires data process information for specifying a process on the data acquired by the MFP 101 on the basis of the user's operation input from the operation unit 804.

Then, the output determining unit 15 determines whether the process specified by the data process information is the output process to a sheet on the basis of the data process information. Subsequently, the operation mode determining unit 11 constructs the information on the determination result, and sends the constructed information to the process controller 13.

The process controller 13 determines the core (functional block) performing a data encrypting process on the basis of the information on the determination result acquired from the output determining unit 15. For example, the output determining unit 15 may determine that the process specified by the data process information is the output process to a sheet. In this case, the process controller 13 determines that the first encryption processor 21 is used to perform the data encrypting process on the basis of the information on the determination result and the data process table and the functional block setting table stored in the memory 802. The output determining unit 15 may determine that the process specified by the data process information is not the output process to a sheet. In this case, the process controller 13 determines that the second encryption processor 21 is used to perform the data encrypting process on the basis of the information on the determination result and the data process table and the functional block setting table stored in the memory 802.

In the second embodiment, in determining the functional block performing the encryption process, the core (functional block) of the encryption process corresponding to the process on the acquired data maybe different from the previously set core (functional block) of the encryption process. At this time, the process controller 13 switches the functional block on the basis of the information on the determination result and the data process table and the functional block setting table stored in the memory 802 so that the encryption process is performed using the functional block corresponding to the process on the acquired data. When the functional block performing the data encrypting process is switched, the process controller 13 constructs the information on the switching and sends the constructed information to the power supply restrictor 25. In the second embodiment, the process controller 13 registers the functional block newly performing the encryption process in the functional block setting table.

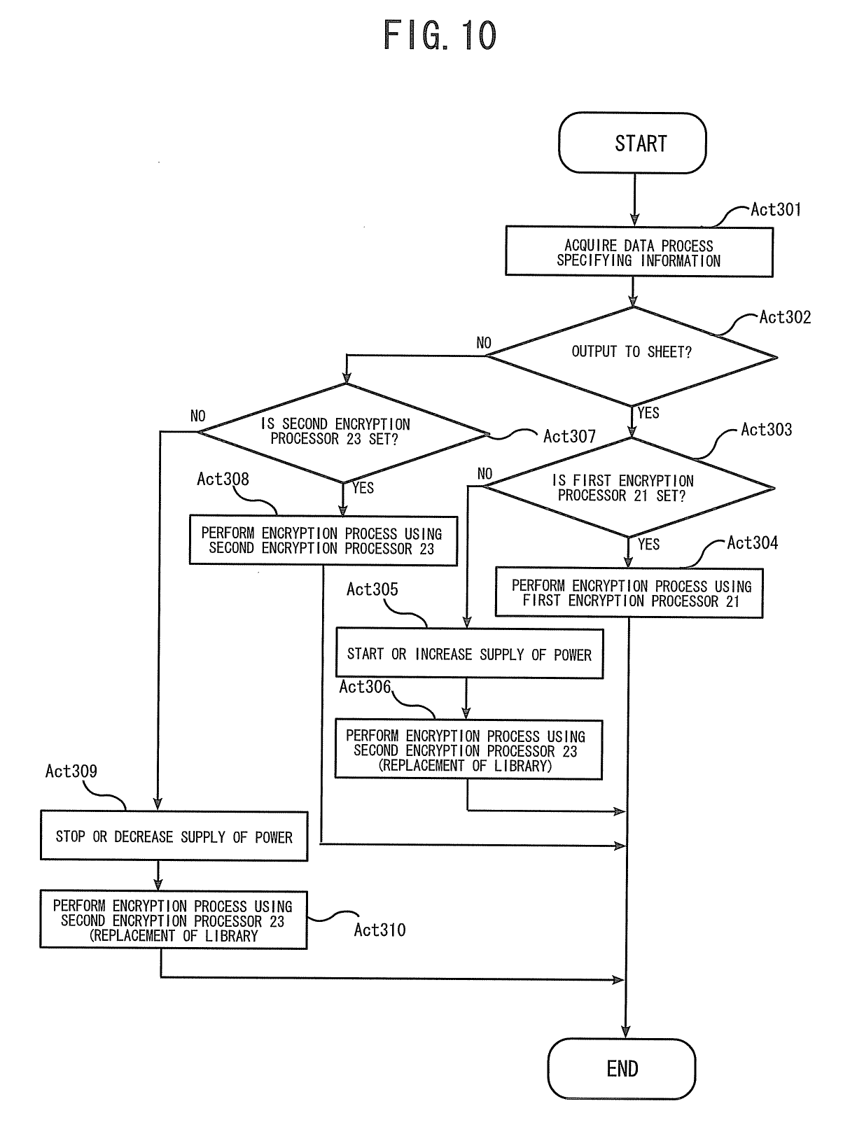

A flow of processes of the encryption process control according to the second embodiment will be described with reference to FIG. 10.

First, in Act 201, the output determining unit 15 acquires the data process information, which is input in response to an operation input, for specifying a process on the data acquired by the MFP 101.

Then, in Act 202, the output determining unit 15 determines whether the process specified by the acquired data process information is the output process to a sheet. When it is determined that the specified process is the output process to a sheet (Yes in Act 202), the output determining unit 15 sends the information on the determination result indicating that the specified process is the output process to a sheet to the process controller 13. In Act 203, the process controller 13 specifies that the functional block performing the encryption process on the acquired data is the first encryption processor 21 on the basis of the information on the determination result and the data process table, and determines whether the first encryption processor 21 is set in advance as the functional block performing the encryption process on the basis of the functional block setting table.

When it is determined that the functional block performing the encryption process is set in advance to the first encryption processor 21 (Yes in Act 203), the process controller 31 causes the first encryption processor 21 to perform the encryption process without any change in Act 204.

On the other hand, it may be determined in Act 203 that the first encryption processor 21 is not set as the functional block performing the encryption process (No in Act 203). In this case, in Act 205, the process controller 13 switches the loaded library from the second library to the first library so as to cause the first encryption processor 21 to perform the encryption process. Then, the process controller 13 constructs the information indicating that the functional block performing the encryption process is switched from the second encryption processor 23 to the first encryption processor 21, and sends the constructed information to the power supply restrictor 25. The process controller 13 registers the switching to the functional block setting table. Specifically, the process controller checks a check box corresponding to the first encryption processor 21 and registers the first encryption processor 21 as the functional block performing the encryption process.

The power supply restrictor 25 controls the second power source to release (that is, to restart or increase the supply of power) the restriction of the supply of power on the basis of the information indicating that the functional block performing the encryption process is switched from the second encryption processor 23 to the first encryption processor 21 (Act 206). Accordingly, the supply of power to the first encryption processor 21 and the circuit operating in interlock with the encryption process using the first encryption processor 21 from the second power source is restarted or increased.

It may be determined in Act 202 that the information specified by the data process information is not the output process to a sheet (No in Act 202). In this case, the output determining unit 11 sends the information on the determination result indicating that the process on the acquired data is not the output process to a sheet to the process controller 13. In Act 207, the process controller 13 specifies that the functional block performing the encryption process on the acquired data is the second encryption processor 23 on the basis of the information on the determination result and the data process table, and determines whether the second encryption processor 23 is set in advance as the functional block performing the encryption process on the basis of the functional block setting table.

When it is determined that the functional block performing the encryption process is set in advance to the second encryption processor 23 (Yes in Act 207), the process controller 31 causes the second encryption processor 23 to perform the encryption process without any change in Act 208.

On the other hand, it may be determined in Act 207 that the second encryption processor 23 is not set as the functional block performing the encryption process (No in Act 207). In this case, in Act 209, the process controller 13 switches the loaded library from the first library to the second library so as to cause the second encryption processor 23 to perform the encryption process. Then, the process controller 13 constructs the information indicating that the functional block performing the encryption process is switched from the first encryption processor 21 to the second encryption processor 23, and sends the constructed information to the power supply restrictor 25. The process controller 13 registers the switching in the functional block setting table. Specifically, the check box corresponding to the second encryption processor 23 is checked and the second encryption processor 23 is registered as the functional block performing the encryption process.

The power supply restrictor 25 controls the second power source to restrict (that is, to stop or decrease the supply of power) the supply of power on the basis of the information indicating that the functional block performing the encryption process is switched from the first encryption processor 21 to the second encryption processor 23 (Act 210). Accordingly, the supply of power to the first encryption processor 21 and the circuit operating in interlock with the encryption process using the first encryption processor 21 from the second power source is stopped or decreased.

### Other Embodiments

While the invention is described above, the invention is not limited to the description, but may be modified in other embodiments.

For example, in the first and second embodiments, the operation mode specifying information and the data process specifying information are acquired on the basis of the operation input from the operation unit 804. However, such information may be received via a network without restricting these first and second embodiments.

The operation mode information in the first embodiment and the data process information in the second embodiment are exemplified as the information on the operation status of the image forming apparatus. However, other embodiments may be employed without restricting this. For example, the functional block performing the encryption process may be switched between the first encryption processor 21 and the second encryption processor 23 on the basis of information indicating the temperature of the fixing unit. The functional block performing the encryption process may be switched between the first encryption processor 21 and the second encryption processor 23 on the basis of the number of sheets on which images are printed out or the functions to be performed.

In the first and second embodiments, the power source supplying power to the CPU 801 and the like and the power source supplying power to the first encryption processor 21 mounted as a circuit on the MFP 101 are separately provided. However, another embodiment may be employed, as long as the encryption process can be performed using the second encryption processor 23 mounted as a program on the MFP 101 and the supply of power to the first encryption processor 21 can be stopped or decreased.

For example, the CPU 801 and the first encryption processor 21 are supplied with power from a single power source and a switch which can stop or restart the supply of power to the first encryption processor 21 may be disposed in the middle way of the circuit.

A program for causing a computer of the MFP 101 to perform the above-mentioned operations can be provided as an encryption process control program. In the first and second embodiments, the program for embodying the functions according to the invention is recorded in advance in a memory area in the MFP 101, but the invention is not limited to this embodiment. The program may be downloaded to the apparatus from a network or the program stored in a computer-readable recording medium may be installed in the apparatus. The recording medium is not particularly limited as long as it can store the program and can be read by a computer. Specifically, examples of the recording medium can include an internal memory device such as a ROM or a RAM mounted on a computer, a portable storage medium such as a CD-ROM, a flexible disk, a DVD, a magneto-optical disk, and an IC card, a database storing and holding computer programs, another computer and a database thereof, and a transmission medium in connections. The functions installed in advance or downloaded may be embodied by interlocking with an OS (Operating System) or the like of the apparatus.

The program according to this embodiment may include a program in which execution modules are dynamically generated.

While specific embodiments of the invention are described above in detail, it will be easily understood by those skilled in the art that the invention can be modified and reformed in various forms without departing from the spirit and scope of the invention.

According to the invention, since the configuration capable of performing an encryption process using one of an encryption function mounted as a circuit and an encryption function mounted as a program is provided, it is possible to reduce the power consumption in comparison with the case where an encryption process is performed using only the encryption function mounted as a circuit.

What is claimed is:

1. An image forming apparatus comprising:
a first encryption processor mounted as hardware to perform a data encrypting process;
a second encryption processor mounted as software to perform a data encrypting process;
a process controller determining which of the first encryption processor and the second encryption processor should be used to perform an encryption process on the basis of information on an operation status of the image forming apparatus; and
a power supply restrictor stopping a supply of power to the first encryption processor when the process controller determines that the second encryption processor is used to perform the encryption process.

2. The apparatus according to claim 1, wherein the image forming apparatus has a first operation mode and a second operation mode in which the power consumption is smaller than that of the first operation mode,
wherein the image forming apparatus further comprises an operation mode determining unit determining whether an operation mode in which the image forming apparatus performs the encryption process is the second operation mode on the basis of operation mode information which is information on the operation mode of the image forming apparatus, and
wherein the process controller determines that the second encryption processor is used to perform the encryption process when the operation mode determining unit determines that the operation mode in which the image forming apparatus performs the encryption process is the second operation mode, and determines that the first encryption processor is used to perform the encryption process when the operation mode determining unit determines that the operation mode in which the image forming apparatus performs the encryption process is the first operation mode.

3. The apparatus according to claim 2, further comprising a fixing unit fixing a toner image transferred onto a sheet to the sheet by heating the toner image,
wherein the fixing unit is stopped when the operation mode of the image forming apparatus is the second operation mode.

4. The apparatus according to claim 1, further comprising an output determining unit determining whether the image forming apparatus outputs data to a sheet on the basis of data process information which is information on a process performed on the data,
wherein the process controller determines that the first encryption processor is used to perform the encryption process when the output determining unit determines that the image forming apparatus outputs the data to the sheet, and determines that the second encryption processor is used to perform the encryption process when the output determining unit determines that the image forming apparatus does not output the data to the sheet.

5. The apparatus according to claim 1, wherein the image forming apparatus is supplied with power from a plurality of power sources, and
wherein power is supplied to the first encryption processor from the power source different from the power source for causing the second encryption processor to perform the encryption process, when the first encryption processor is used to perform the encryption process.

6. The apparatus according to claim 1, wherein the supply of power to the hardware operating in interlock with the encryption process performed by the first encryption processor is stopped by interlocking with the stop of the supply of power to the first encryption processor, when the process controller determines that the second encryption processor is used to perform the encryption process.

7. An encryption process control method comprising:
determining which of an encryption process based on a first encryption function of an image forming apparatus mounted as hardware on the image forming apparatus and an encryption process based on a second encryption function of the image forming apparatus mounted as software on the image forming apparatus should be used to encrypt data on the basis of information on an operation status of the image forming apparatus performing an encryption process; and
stopping a supply of power to the hardware corresponding to the first encryption function when it is determined that the encryption process based on the second encryption function is used to encrypt data.

8. The method according to claim 7, wherein the image forming apparatus has a first operation mode and a second operation mode in which the power consumption is smaller than that of the first operation mode,
wherein it is determined whether an operation mode in which the image forming apparatus performs the encryption process is the second operation mode on the basis of operation mode information which is information on the operation mode of the image forming apparatus,
wherein it is determined that the encryption process based on the second encryption function is performed when it is determined that the operation mode in which the image forming apparatus performs the encryption process is the second operation mode; and
wherein it is determined that the encryption process based on the first encryption function is performed when it is determined that the operation mode in which the image forming apparatus performs the encryption process is the first operation mode.

9. The method according to claim 8, wherein the image forming apparatus includes a fixing unit fixing a toner image transferred onto a sheet to the sheet by heating the toner image,
wherein the fixing unit is stopped when the operation mode of the image forming apparatus is the second operation mode.

10. The method according to claim 7, wherein it is determined whether the image forming apparatus outputs data to a sheet on the basis of data process information which is information on a process performed on the data by the image forming apparatus,
wherein it is determined that the encryption process based on the first encryption function is performed when it is determined that the image forming apparatus outputs the data to the sheet, and
wherein it is determined that the encryption process based on the second encryption function is performed when it is determined that the image forming apparatus does not output the data to the sheet.

11. The method according to claim 7, wherein the image forming apparatus is supplied with power from a plurality of power sources, and
wherein power is supplied to the hardware corresponding to the first encryption function from the power source different from the power source for causing the encryption process based on the second encryption function to be performed, when the encryption process based on the first encryption function is performed.

12. The method according to claim 7, wherein the supply of power to the hardware operating in interlock with the encryption process based on the first encryption function is stopped or decreased by interlocking with the stop of the supply of power to the circuit corresponding to the first encryption function, when it is determined that the encryption process based on the second encryption function is performed.

13. An image forming apparatus comprising:
a first encryption processor mounted as hardware to perform a data encrypting process;
a second encryption processor mounted as software to perform a data encrypting process;
a process controller determining which of the first encryption processor and the second encryption processor should be used to perform a data encryption process on the basis of information on an operation status of the image forming apparatus; and
a power supply restrictor decreasing a supply of power to the first encryption processor when the process controller determines that the second encryption processor is used to perform the encryption process.

14. The apparatus according to claim 13, wherein the image forming apparatus has a first operation mode and a second operation mode in which the power consumption is smaller than that of the first operation mode,
wherein the image forming apparatus further comprises an operation mode determining unit determining whether an operation mode in which the image forming apparatus performs the encryption process is the second operation mode on the basis of operation mode information which is information on the operation mode of the image forming apparatus, and
wherein the process controller determines that the second encryption processor is used to perform the encryption process when the operation mode determining unit determines that the operation mode in which the image forming apparatus performs the encryption process is the second operation mode, and determines that the first encryption processor is used to perform the encryption process when the operation mode determining unit determines that the operation mode in which the image forming apparatus performs the encryption process is the first operation mode.

15. The apparatus according to claim 14, further comprising a fixing unit fixing a toner image transferred onto a sheet to the sheet by heating the toner image,
wherein the fixing unit is stopped when the operation mode of the image forming apparatus is the second operation mode.

16. The apparatus according to claim 13, further comprising an output determining unit determining whether the image forming apparatus outputs data to a sheet on the basis of data process information which is information on a process performed on the data,
wherein the process controller determines that the first encryption processor is used to perform the encryption process when the output determining unit determines that the image forming apparatus outputs the data to the sheet, and determines that the second encryption processor is used to perform the encryption process when the output determining unit determines that the image forming apparatus does not output the data to the sheet.

17. The apparatus according to claim 13, wherein the image forming apparatus is supplied with power from a plurality of power sources, and
wherein power is supplied to the first encryption processor from the power source different from the power source for causing the second encryption processor to perform the encryption process, when the first encryption processor is used to perform the encryption process.

18. The apparatus according to claim 13, wherein the supply of power to the hardware operating in interlock with the encryption process performed by the first encryption processor is decreased by interlocking with the decrease of the supply of power to the first encryption processor, when the process controller determines that the second encryption processor is used to perform the encryption process.
